(19) United States
(12) Patent Application Publication
(10) Pub. No.: US 2008/0141092 A1
(43) Pub. Date: Jun. 12, 2008

(54) Network protocol for network communications

(76) Inventor: John M. Holt, Essex (GB)

Correspondence Address: PERKINS COIE LLP, P.O. BOX 2168, MENLO PARK, CA, 94026, US

(21) Appl. No.: 11/973,353

(22) Filed: Oct. 5, 2007

Related U.S. Application Data
(60) Provisional application No. 60/850,505, filed on Oct. 9, 2006.
(60) Provisional application No. 60/850,537, filed on Oct. 9, 2006.

(30) Foreign Application Priority Data
Oct. 5, 2006 (AU) 2006905504
Oct. 5, 2006 (AU) 2006905534

(51) Int. Cl. G08C 25/00

(52) U.S. Cl. 714/748

(57) ABSTRACT

A network protocol is disclosed in which the network switch reports failure to transmit a message or packet to the source computer of a multiple computer system. The destination computer(s) is/are then instructed by the source computer to re-initialize the relevant memory locations. A transaction identifier (TID) is used to identify a source computer sending a stream of updating data for a specific memory location.

### CROSS REFERENCE TO RELATED APPLICATIONS

The present application claims the benefit of priority to U.S. Provisional Application Nos. 60/850,505 (5027CY-US) and 60/850,537 (5027Y-US), both filed 9 Oct. 2006; and to Australian Provisional Application Nos. 2006905504 (5027CY-AU) and 2006905534 (5027Y-AU), both filed on 5 Oct. 2006, each of which are hereby incorporated herein by reference.

This application is related to concurrently filed U.S. Application entitled “Network Protocol For Network Communications,” (Attorney Docket No. 61130-8036.US01 (5027CY-US01)), which is hereby incorporated herein by reference.

### FIELD OF THE INVENTION

The present invention relates to the transmission of data in a communications network interconnecting at least one source of data and at least one destination for that data. The invention finds particular application in the transmission of data in replicated shared memory, or partial or hybrid replicated shared memory, multiple computer systems. However, the present invention is not restricted to such systems and finds application in other fields including the transmission of asynchronous data, for example of stock exchange prices.

### BACKGROUND

For an explanation of a multiple computer system incorporating replicated shared memory, or hybrid replicated shared memory, reference is made to the present applicant's International Patent Application No. WO 2005/103926 Attorney Ref 5027F-WO (to which U.S. patent application Ser. No. 11/111,946 corresponds), and to International Patent Application No. PCT/AU2005/001641 (WO 2006/110,937) Attorney Ref. 5027F-D1-WO) to which U.S. patent application Ser. No. 11/259,885 corresponds. In addition, reference is made to Australian Patent Application No. 200 582 Attorney Ref 50271 (to which U.S. patent application Ser. No. 11/583,958 No. (60/730,543) and PCT/AU2006/001447(WO 2007/041762) corresponds) and to International Patent Application No. PCT/AU2007/ . . . which claims priority from Australian Patent Application No. 2006 905 534 both entitled “Hybrid Replicated Shared Memory Architecture” Attorney Ref 5027Y to which U.S. Patent Application No. 60/850,537 corresponds. The disclosure of all these specifications is hereby incorporated into the present specification by cross-reference for all purposes.

Briefly stated, the abovementioned patent specifications disclose that at least one application program written to be operated on only a single computer can be simultaneously operated on a number of computers each with independent local memory. The memory locations required for the operation of that program are replicated in the independent local memory of each computer. On each occasion on which the application program writes new data to any replicated memory location, that new data is transmitted and stored at each corresponding memory location of each computer. Thus apart from the possibility of transmission delays, each computer has a local memory the contents of which are substantially identical to the local memory of each other computer and are updated to remain so. Since all application programs, in general, read data much more frequently than they cause new data to be written, the abovementioned arrangement enables very substantial advantages in computing speed to be achieved. In particular, the stratagem enables two or more commodity computers interconnected by a commodity communications network to be operated simultaneously running under the application program written to be executed on only a single computer.

Conventional communications networks utilise the concept of a channel which may be likened to a series of conversations which take place between the source and the destination. The source keeps a copy of the transmitted message until the destination confirms receipt of the message. The source machine re-transmits the message if no receipt is received within some specified period, or if the destination received a corrupt message etc. Such an arrangement works relatively well in telephony or in transmitting internet traffic. However, replicated shared memory multiple computer systems generate heavy traffic on the communications network interconnecting the various computers. Such traffic can typically be of the order of a gigabit per second. A gigabit of data is approximately equal to one week's browsing by a sole individual on the internet. In view of this heavy traffic it is apparent that in order for the communications network to operate successfully, a transmission protocol must be used in which the source does not keep a copy of each message despatched or transmitted, and yet can gracefully recover from failed, broken, or missing transmissions.

### GENESIS OF THE INVENTION

The genesis of the present invention is a realization that the prior art arrangement was to some extent based upon a pessimistic view of network reliability and that in the past the reliability of communications networks was much lower than the current reliability of modern communications networks. As a consequence, an optimistic view as to the likelihood of success of the transmission can be taken. This optimistic view leads to the conclusion that a transmission protocol which is relatively slow to recover in the event of failure to successfully transmit a message is acceptable because the number of such failures is very low.

### SUMMARY OF THE INVENTION

In accordance with a first aspect of the present invention there is disclosed a transmission protocol for transmission of data in a communication network interconnecting at least one source of data and at least one destination for that data, said protocol comprising a payload comprising said data and a header comprising a transaction identifier, a destination address and a source address

In accordance with a second aspect of the present invention there is disclosed a transmission protocol for transmission of replica memory updating data in a communication network interconnecting a plurality of computers operating as a replicated shared memory arrangement, each of said computers containing and independent local memory and each said computer executing a same application program written to operate on a single computer, with at least one application memory location replicated in the independent local memory of each said computer and updated to remain substantially similar, with at least one source of data and at least one destination for that updating data, said protocol comprising a payload comprising said data and a header comprising a transmission identifier, a destination address and a source address.

In accordance with a third aspect of the present invention there is disclosed a modification of either of the abovementioned transmission protocols in which the transaction identifier is omitted and the data of the payload has previously been signalled as being part of a sequence of data from the same data source to the same data destination.

In accordance with a fourth aspect of the present invention there is disclosed in a communications network in which data packets are transmitted via at least one multi-port switch from a source to at least one destination, the method comprising the steps of:

(i) providing the or each switch with a data processing capacity,
(ii) having said switch notify said source of any failure to deliver a packet sent from said source to any one or more of said destination(s).

In accordance with a fifth aspect of the present invention there is disclosed a method of recovery of substantially coherent replicated application memory in a replicated shared memory, or partial replicated shared memory, multiple computer system in the event of unsuccessful replica memory update data transmission from a source computer to one or more destination computers each of which form part of said multiple computer system and said data unsuccessfully transmitted comprises the updated content of a replicated application memory location/content replicated in each of said source computer and said destination computer(s), and where each of said computers contains an independent local memory and each said computer is operating an application program written to operate on only a single computer, and with at least one application memory location/content replicated in each of said computers and updated to remain substantially similar, said method comprising the steps of:

(i) said source computer on becoming aware of said unsuccessful data transmission instructing said destination computer to re-initialise the replicated application memory location(s)/content(s) to which the undelivered data relates by re-initializing said replicated application memory location(s)/content(s) to which the undelivered data relates, and

(ii) said source computer sending said destination computer its current contents of said replicated application memory location(s)/content(s) to which the undelivered data related.

In accordance with a sixth aspect of the present invention there is disclosed in a communications network in which data packets are transmitted via at least one multi-port switch from a source to at least one destination, the method comprising the steps of:

(i) providing the or each switch with a data processing capacity,

(ii) having said switch notify said source of any failure to deliver a packet sent from said source to any one or more of said destination(s).

### BRIEF DESCRIPTION OF THE DRAWINGS

A preferred embodiment of the invention will now be described with reference to the accompanying drawings in which:

FIG. 1 is a schematic representation of a multiple computer system,

FIG. 1A is a schematic representation of an RSM multiple computer system,

FIG. 1B is a similar schematic representation of a partial or hybrid RSM multiple computer system

FIG. 2 is a representation of the network of FIG. 1 in which the communications network is realised as a switch, and

FIG. 3 is a representation of the headers and payloads of the transmission protocol of the preferred embodiment.

### DETAILED DESCRIPTION

As seen in FIG. 1, a multiple computer system comprises “n” computers C1, C2, . . . Cn where “n” is an integer greater than or equal to two. The individual computers are interconnected by means of a communications network 53.

As explained in the abovementioned specifications incorporated by cross reference, in a replicated shared memory multiple computer system, that portion of the application memory concerned with the application program operating on the multiple computer system is replicated in each of the computers C1, C2, . . . Cn. However, in a partial or hybrid replicated shared memory multiple computer system only some of the application memory locations/contents associated with the execution of the application program are replicated in the various computers. Irrespective of which type of multiple computer system is used, where a computer such as, say, C2 updates (for example, writes a new value to) a specific replicated application memory location/content which is replicated in one or more of the other computers, then that updated information (that is, the updated replica value) is sent via the communications network 53 (such as via a replica memory update transmission) to each of the other computers C1, C3, . . . Cn in order to maintain the corresponding replica application memory locations/contents substantially similar/coherent. That is, the replicated application memory locations/contents have the same content or value for corresponding local replica application memory locations/contents, apart from relatively minor updating delays caused by the network interconnecting the machines to transmit updated contents from on computer to another.

FIG. 1A is a schematic diagram of a replicated shared memory system. In FIG. 1A three machines are shown, of a total of “n” machines (n being an integer greater than one) that is machines M1, M2, . . . Mn. Additionally, a communications network 53 is shown interconnecting the three machines and a preferable (but optional) server machine X which can also be provided and which is indicated by broken lines. In each of the individual machines, there exists a memory 102 and a CPU 103. In each memory 102 there exists three memory locations, a memory location A, a memory location B, and a memory location C. Each of these three memory locations is replicated in a memory 102 of each machine.

This arrangement of the replicated shared memory system allows a single application program written for, and intended to be run on, a single machine, to be substantially simultaneously executed on a plurality of machines, each with independent local memories, accessible only by the corresponding portion of the application program executing on that machine, and interconnected via the network 53. In International Patent Application No PCT/AU2005/001641 (WO2006/110,937) (Attorney Ref 5027F-D1-WO) to which U.S. patent application Ser. No. 11/259,885 entitled: “Computer Architecture Method of Operation for Multi-Computer Distributed Processing and Co-ordinated Memory and Asset Handling” corresponds, a technique is disclosed to detect modifications or manipulations made to a replicated memory location, such as a write to a replicated memory location A by machine M1 and correspondingly propagate this changed value written by machine M1 to the other machines M2 . . . Mn which each have a local replica of memory location A. This result is achieved by the preferred embodiment of detecting write instructions in the executable object code of the application to be run that write to a replicated memory location, such as memory location A, and modifying the executable object code of the application program, at the point corresponding to each such detected write operation, such that new instructions are inserted to additionally record, mark, tag, or by some such other recording means indicate that the value of the written memory location has changed.

An alternative arrangement is that illustrated in FIG. 1B and termed partial or hybrid replicated shared memory (RSM). Here memory location A is replicated on computers or machines M1 and M2, memory location B is replicated on machines M1 and Mn, and memory location C is replicated on machines M1, M2 and Mn. However, the memory locations D and E are present only on machine M1, the memory locations F and G are present only on machine M2, and the memory locations Y and Z are present only on machine Mn. Such an arrangement is disclosed in Australian Patent Application No. 2005 905 582 Attorney Ref 50271 (to which U.S. patent application Ser. No. 11/583,958 (60/730,543) and PCT/AU2006/001447 (WO2007/041762) correspond). In such a partial or hybrid RSM systems changes made by one computer to memory locations which are not replicated on any other computer do not need to be updated at all. Furthermore, a change made by any one computer to a memory location which is only replicated on some computers of the multiple computer system need only be propagated or updated to those some computers (and not to all other computers).

Consequently, for both RSM and partial RSM, a background thread task or process is able to, at a later stage, propagate the changed value to the other machines which also replicate the written to memory location, such that subject to an update and propagation delay, the memory contents of the written to memory location on all of the machines on which a replica exists, are substantially identical. Various other alternative arrangements are also disclosed in the abovementioned specification.

As indicated in FIG. 2, the communications network 53 may be considered to be a multi-path switch. Thus, if computer C1 is to send an updating message to computer C3, for example, then terminal A is effectively connected to terminal C. Similarly, if computer C2 is to send an updating message to computer Cn, then terminal B is effectively connected to terminal Z, and so on.

Since the switch or communications network 53 does not contain any logic for the purposes of a replicated shared memory arrangement, the switch or communications network 53 is regarded as being “dumb”. For example, it does not substantially read or substantially examine or substantially understand the content of the message(s) being conveyed. Thus, if a particular computer should have a full receive buffer which is not emptied, then subsequent messages sent to that computer are not delivered and are typically discarded. Typically, the switch or communications network 53 or the transmitting machine is unable to tell that the delivery has failed. Instead, the source or transmitting computer eventually finds out about the failed delivery as a result of a failure of the destination computer or machine to respond as expected, or as a result of the destination computer signalling to the transmitting machine via a separate message/transmission the failed receipt of one or more transmitted messages/transmissions by the destination machine.

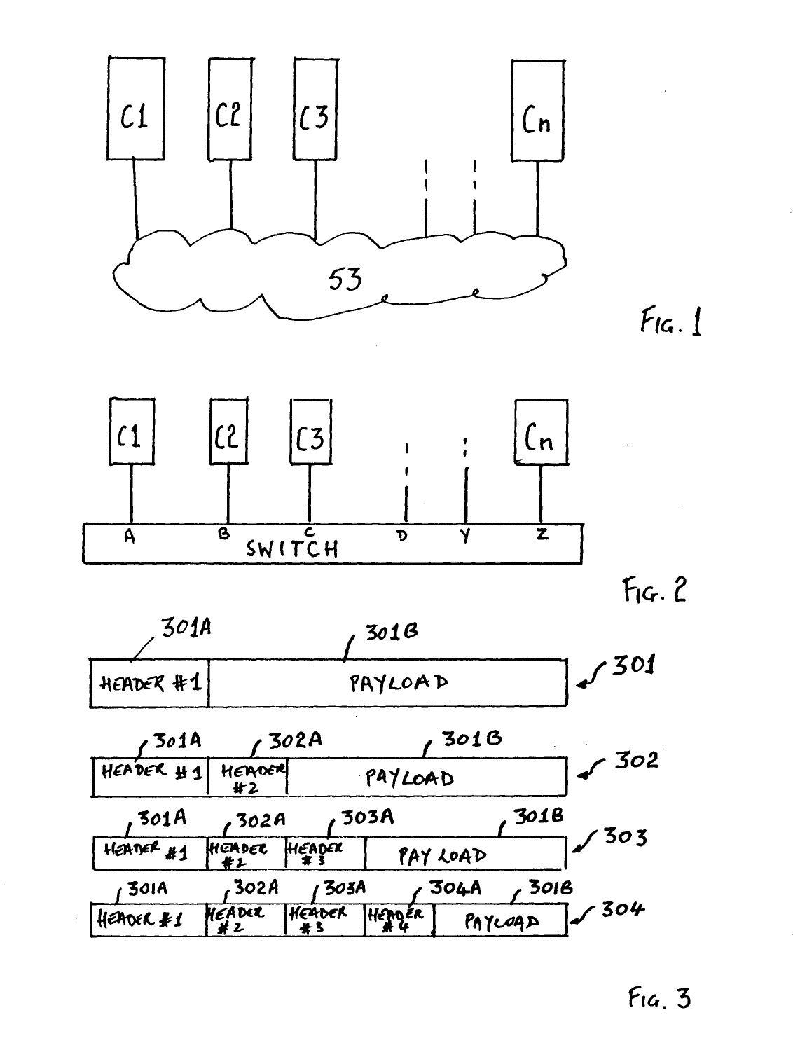

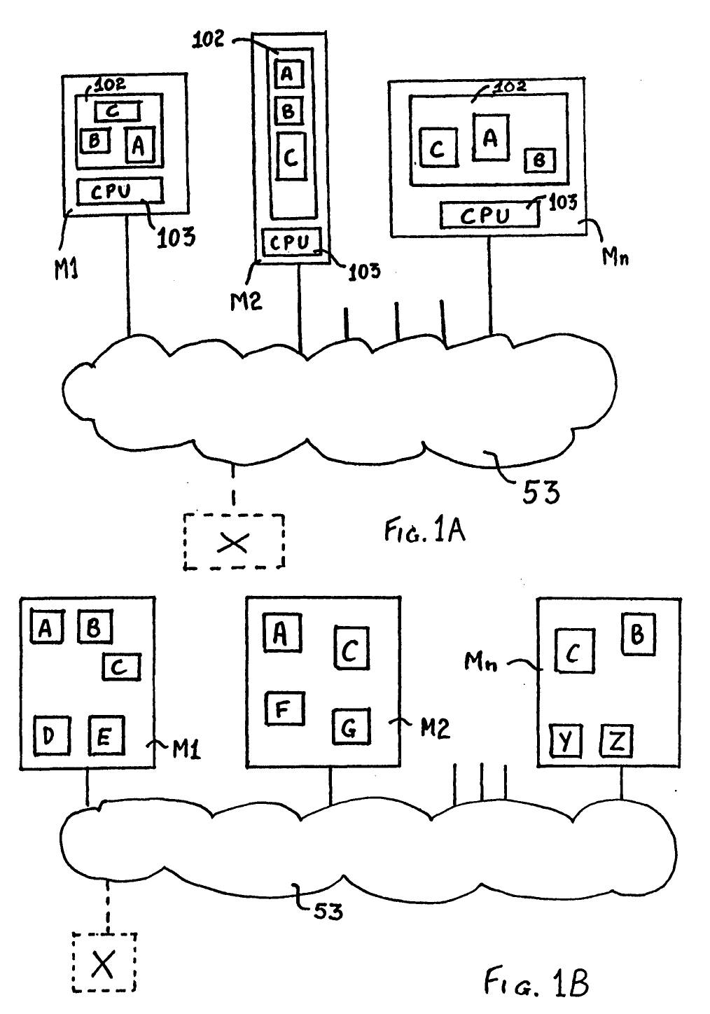

FIG. 3 illustrates a four example protocol arrangements of the prior art. Specifically, the 4 prior art protocol arrangements illustrate a scheme of “nested headers and payloads” as is typically utilized in the transmission protocols of multiple layers of a network communications process (such as for example layers 2, 3, 4 etc). As indicated by the first example message/transmission 301 of FIG. 3, the first header 301A may contain various housekeeping items including the address to which the message is to be delivered. The remainder of the message 301B is considered to be the (first) payload.

As indicated in the second level 302 of FIG. 3, the initial part of the first payload 301B of the upper level 301 constitutes a second header 302A and the remainder of the first payload constitutes the second payload which follows the second header. This process is repeated in turn for a third header 303A and a fourth header 304A as indicated in the lowest level of FIG. 3.

In accordance with the preferred embodiment of the present invention, a “replica transmission identifier” (or any of various described and anticipated alternatives) may occupy any position of a packet/message protocol. For example, such “replica transmission identifier(s)” may reside in any of the four headers 301A, 302A, 303A, or 304A. Alternatively, such “replica transmission identifier(s)” may reside in the payload 301B (with any combination of headers).

Preferably, such a “replica transmission identifier” constitutes only two bytes and a specific “replica transmission identifier” value is preferably associated with a same replicated application memory location(s)/content(s) of the transmitting machine for some period of time, since operation of a prototype multiple computer system operating as a replicated shared memory arrangement has shown that once an initial write to a replicated application memory location/content has taken place, this is often followed by multiple additional writes to the same replicated application memory location/content.

In the replica memory update transmission protocol of the preferred embodiment, there is no attempt made by a transmitting machine to store any copy of the packet(s) or message(s) representing a single replica memory update transmission being sent in order to wait for positive confirmation of receipt by the one or more destination machines. Subsequent packets or messages are thus sent prior to any receipt of confirmation, and are not buffered or stored following transmission so as to be able to be resent upon condition failed transmission. Thus, should a failed replica memory update transmission of one or more packets or messages occur, there does not existing on the sending/transmitting machine a copy of the failed packets or messages able to be resent.

Specifically, in a preferred embodiment of the present invention, each replica memory update transmission includes a “replica transmission identifier” or other identifier or value of the transmitting machine which is uniquely associated with the replicated application memory location/content to which such replica memory update transmission corresponds. Preferably, a single “replica transmission identifier” is associated with multiple, or all of, replica memory update transmissions for a same replicated application memory location(s)/content(s). Further preferably, each one of potentially multiple messages or packets or cells or frames or the like representing a single replica memory update transmission preferably includes the associated “replica transmission identifier” of the replica memory update transmission.

Additionally, the switch is modified by the inclusion of a logic processing capability to report any failure to deliver a message or packet of a replica memory update transmission. Specifically, upon occasion of a switch failing to deliver a replica memory update transmission (and/or the packets or messages comprising such transmission) to one or more destinations, then the switch sends at least one “failure to deliver” notifying message to the transmitting machine informing the transmitting machine of the failed transmission condition, including the identity of the failed destination machines and the identity of the effected replica memory update transmission(s).

More specifically, such notifying message preferably contains the identity of the one or more destination machines to which a replica memory update transmission (comprising one or more packets or messages) was failed to be sent, or was unable to be sent. Additionally, such notifying message also contains the “replica transmission identifiers” or other identifier or value of the transmitting machine associated with the failed replica memory update transmission(s). Thus, if a packet or message of a replica memory update transmission cannot be delivered, the switch sends an emergency message to the source (transmitting) computer informing it that the destination address has developed a fault corresponding to the “replica transmission identifier” of the failed replica memory updated transmission that has not been delivered (or was not able to be ensured to be wholly delivered).

For example, if the communication link to one computer, say computer C3, is momentarily inoperable, for example due to a full receive buffer on the destination machine C3, then a message sent from say, computer C1, would not be successfully transmitted to destination computer C3. In these circumstances, the switch reads the “replica transmission identifier” of the failed replica memory update transmission/packet/message, discards the failed message, and uses the read “replica transmission identifier” to notify the source computer C1 of the failure to deliver the message or packet to the destination computer C3, and the “replica transmission identifier” of the failed packet or message.

Corresponding to a transmitting machine receiving a notifying message containing a “replica transmission identifier” of a failed replica memory update transmission, the transmitting machine commences a replica re-initialization of the replicated application memory location(s)/content(s) corresponding to the received “replica transmission identifier”. So further to the example above, the source computer C1 instructs the destination computer C3 to re-initialize the corresponding local replica application memory location(s)/content(s) corresponding to the undelivered message/transmission. The source computer C1 does this by transmitting the current value(s) or content(s) of the local/resident replica application memory location(s)/content(s) of the source computer (e.g. computer C1) corresponding to the received “replica transmission identifier” and failed replica memory update transmission(s), to the one or more failed destination computer(s) (e.g. computer C3).

In this connection thus, it is to be understood that by the time computer C1 arranges for the re-initialization of destination computer C3, the content of the relevant memory location within computer C1 may have changed due to the continued operation of computer C1.

Preferably, if the replicated application memory location(s)/content(s) to which a failed “replica transmission identifier” corresponds to (that is, is part of, or a member of) a set or plurality of related application memory locations/values, then such replica re-initialization transmission preferably includes the re-initialisation of each single location/value/content comprising such related set of multiple replicated application memory locations/values. Examples of a plurality of related application memory locations may include for example the elements of an array data structure, the fields of an object, the fields of a class, the memory locations of a virtual memory page, or the like.

In co-pending International Patent Application No. PCT/AU2007/ . . . (Attorney Ref. 5027T-WO) by the present applicant, lodged simultaneously herewith and entitled “Advanced Contention Detection” and claiming priority from Australian Provisional Patent Application No. 2006 905 527 (to which U.S. Patent Application No. 60/850,711 corresponds) a system of identifying sequentially updated data utilizing a “count value” and/or “resolution value” is disclosed. The “count value” is indicative of the position of a particular data packet in a sequence of data packets, whilst the “resolution value” is a unique value associated with a transmitting machine. Additionally disclosed is a local memory storage arrangement whereby for each local replica application memory location/content stored in the local memory of each machine, there is also stored an associated “count value” and/or “resolution value” for each local replica application memory location/content. The contents of that specification are hereby incorporated into the present application for all purposes.

Briefly stated, the abovementioned data protocol or message format includes both the address of a memory location where a value or content is to be changed, the new value or content, and a count number indicative of the position of the new value or content in a sequence of consecutively sent new values or content.

Thus a sequence of messages are issued from one or more sources. Typically each source is one computer of a multiple computer system and the messages are memory updating messages which include a memory address and a (new or updated) memory content.

Thus each source issues a string or sequence of messages which are arranged in a time sequence of initiation or transmission. The problem arises that the communication network 53 cannot always guarantee that the messages will be received in their order of transmission. Thus a message which is delayed may update a specific memory location with an old or stale content which inadvertently overwrites a fresh or current content.

In order to address this problem each source of messages includes a count value in each message. The count value indicates the position of each message in the sequence of messages issuing from that source. Thus each new message from a source has a count value incremented (preferably by one) relative to the preceding messages. Thus the message recipient is able to both detect out of order messages, and ignore any messages having a count value lower than the last received message from that source. Thus earlier sent but later received messages do not cause stale data to overwrite current data.

As explained in the abovementioned cross referenced specifications, later received packets which are later in sequence than earlier received packets overwrite the content or value of the earlier received packet with the content or value of the later received packet. However, in the event that delays, latency and the like within the network 53 result in a later received packet being one which is earlier in sequence than an earlier received packet, then the content or value of the earlier received packet is not overwritten and the later received packet is effectively discarded. Each receiving computer is able to determine where the latest received packet is in the sequence because of the accompanying count value. Thus if the later received packet has a count value which is greater than the last received packet, then the current content or value is overwritten with the newly received content or value. Conversely, if the newly received packet has a count value which is lower than the existing count value, then the received packet is not used to overwrite the existing value or content. In the event that the count values of both the existing packet and the received packet are identical, then a contention is signalled and this can be resolved.

This resolution requires a machine which is about to propagate a new value for a memory location, and provided that machine is the same machine which generated the previous value for the same memory location, then the count value for the newly generated memory is not increased by one (1) but instead is increased by more than one such as by being increased by two (2) (or by at least two). A fuller explanation is contained in the abovementioned cross referenced provisional PCT specification.

The abovementioned data protocol or message format includes the address/identity of a replicated application memory location/content of which the value or content has changed, the associated new value or content, and an associated “count value” indicative of the position of the replica memory update transmission comprising the new replica application memory location value or content in a sequence of sent and received replica memory update transmissions for the same replicated application memory location, and/or an associated “resolution value” unique to the transmitting machine of each replica memory update transmission. Thus, a sequence of replica memory update transmissions are issued from one or more machines (sources) of the multiple computer system.

Thus each source issues a string or sequence of replica memory update transmissions which are arranged in a time sequence of initiation or transmission. The problem arises that the communication network 53 cannot always guarantee that the messages will be received in their order of transmission. Thus a message which is delayed may update a specific replica application memory location/content with an old or stale content which inadvertently overwrites a “newer” content (such as may be caused by a earlier sent replica memory update transmission being received after a later sent replica update transmission corresponding to the same replicated application memory location/content).

In order to address this problem each source of messages includes a count value in each replica memory update transmission. The count value indicates the position of each replica update transmission in the sequence of replica memory update transmissions sent or received from that source. Thus each new replica memory update transmission from a source has a count value incremented (preferably by one) relative to the preceeding sent or received replica memory update transmission. Thus the recipient is able to both detect out of order replica memory update transmissions, and ignore any replica memory updates having a “count value” lower than the last received replica memory update transmission. Thus earlier sent but later received replica memory update transmissions do not cause stale (“older”) data to overwrite “newer” data.

As explained in the abovementioned cross reference provisional specifications, later received replica memory update transmissions which are later in sequence than earlier received replica memory update transmissions overwrite the content or value of the earlier received replica memory update transmissions with the content or value of the later received replica memory update transmissions. However, in the event that delays, latency and the like within the network 53 result in a later received replica memory update transmission being one which is earlier in sequence than an earlier received replica memory update transmission, then the updated replica application memory content or value of the earlier received replica memory update transmission is not overwritten and the later received replica memory update transmission is effectively discarded. Each receiving computer is able to determine where the latest received replica memory update transmission is in the sequence because of the accompanying “count value”. Thus if the later received replica memory update transmission has a resident count value which is greater than the last received or sent replica memory update transmission, then the current content or value of the local replica application memory location/content is overwritten with the newly received content or value. Conversely, if the newly received replica memory update transmission has a count value which is lower than the existing resident count value, then the received replica memory update transmission is not used to overwrite the existing value or content of the local replica application memory location/content. In the event that the resident count value and the count value of the received replica memory update transmission are identical, then a contention is signalled and this can be resolved. Various resolution methods are disclosed, whereby a “resolution value” is associated with each “contention value”, and where such “resolution value” is a unique value of the transmitting machine. Such “resolution values” may then be used in circumstances of contention described above in order to resolve the contention circumstance in a similar and consistent manner for all machines. A fuller explanation is contained in the abovementioned cross referenced PCT specification.

Preferably then, the abovementioned replica re-initialization transmission transmits not only the current value(s) or content(s) of the relevant replicated application memory location(s)/content(s) of the source computer, but also any associated resident “count value(s)” and/or “resolution value(s)”. However, unlike regular replica memory update transmissions, a re-initialisation transmission preferably contains unincremented resident “count value(s)” of the associated replica application memory location(s)/content(s), and not incremented “count value(s)” as would be the case for a regular replica memory update transmission (such as would take place for example were the local replica application memory location/content written-to by the application program). The reason why un-incremented resident “count value(s)” are used for re-initialization transmissions is because a re-initialization transmission does not correspond to a change in value of the replicated application memory location(s)/content(s), but instead an initialisation of the current content(s) or value(s) of the replicated application memory location(s)/content(s).

Thus, upon one or more failed destination computer(s) (for example computer C3 of the above example) receiving a replica re-initialisation transmission (such as for example as sent by computer C1), each overwrites the corresponding local/resident replica application memory location(s)/content(s) with the received value(s) or content(s) of the replica re-initialisation transmission. Specifically however, when abovedescribed “count values” and/or “resolution values” are associated with such re-initialised replica application memory location(s)/content(s), then it is necessary for each receiving machine to apply the contention detection and resolution rules associated with such “count values” and “resolution values” (and described in the abovementioned PCT specification) to the actioning of the received re-initialisation transmission and overwriting of corresponding local replica application memory location(s)/content(s). In particular, if the associated contention detection and resolution rules of the “count values” and/or “resolution values” are not followed or observed, and instead the corresponding local replica application memory location(s)/content(s) of the receiving machine are overwritten without consideration (or comparison) of the associated local/resident and received “count values” and/or “resolution values”, then inconsistent updating of the corresponding local replica application memory location(s)/content(s) may result.

Thus, upon receipt of a replica re-initialisation transmission which includes associated “count values” and/or “resolution values” of the replica application memory location(s)/content(s) to which the re-initialisation transmission relates, then prior to the receiving machine overwriting each corresponding local replica application memory location/content with the corresponding received value/content of the replica re-initialisation transmission, the associated “count value” and/or “resolution value” of the received replica re-initialisation transmission and the corresponding local/resident “count value” and/or “resolution value” are compared in accordance with the contention detection and resolution rules so as to determine whether or not the value/content of the local/resident replica application memory location/content is newer than, or already consistent with, or older than, the corresponding value/content of the received replica re-initialisation transmission.

For example, with reference to the contention detection and resolution rules of the abovementioned PCT specification, when a replica re-initialisation transmission is received for one or more replica application memory location(s)/content(s), then the following contention detection and resolution rules apply. Firstly, for each identified replicated application memory location/content of the received transmission, there is also received (preferably as part of the same re-initialisation transmission) the associated current value/content of the transmitting machine at the time of transmission or preparation of the re-initialisation transmission, as well as an associated “count value” and/or “resolution value” of the transmitting machine at the time of transmission or preparation of the re-initialisation transmission.

Secondly, for each identified replicated application memory location/content of the received transmission for which a corresponding local/resident replica application memory location/content exists, then the associated “count value” of the received transmission is compared with the corresponding local/resident “count value” of the receiving machine. If the corresponding “count value” of the received transmission is less than the corresponding local/resident “count value” of the receiving machine, then the value/content of the corresponding local/resident replica application memory location/content is deemed to be “newer” than the received value/content of the received replica re-initialisation transmission. Thus, the local/resident replica application memory location/content is not to be overwritten with the corresponding received value/content of the received replica re-initialisation transmission. Thus also, the corresponding local/resident “count value” and/or “resolution value” are similarly not to be overwritten with the corresponding received “count value” and/or “resolution value” of the received replica re-initialisation transmission.

Alternatively, if the corresponding “count value” of the received replica re-initialisation transmission is greater than the corresponding local/resident “count value” of the receiving machine, then the value/content of the corresponding local/resident replica application memory location/content is “older” than the received value/content of the received replica re-initialisation transmission. Thus, the local/resident replica application memory location/content is to be overwritten with the corresponding received value/content of the received replica re-initialisation transmission. Thus also, the corresponding local/resident “count value” and/or “resolution value” are similarly overwritten with the corresponding received “count value” and/or “resolution value” of the received replica re-initialisation transmission.

Alternatively again, if the corresponding “count value” of the received replica re-initialisation transmission is equal to the corresponding local/resident “count value” of the receiving machine, then a further comparison is made between the corresponding “resolution value” of the received replica re-initialisation transmission and the corresponding local/resident “resolution value” of the received machine. If the compared corresponding “resolution values” are equal, then the value/content of the corresponding local/resident replica application memory location/content is deemed to be consistent/coherent, and therefore the local/resident replica application memory location/content is identical (or should be identical) to the corresponding received value/content of the received replica re-intialisation transmission. Therefore preferably the local/resident replica application memory location/content is not overwritten with the corresponding received value/content of the received replica re-initialisation transmission.

However, if the compared corresponding “resolution values” are not equal, then a “contention”/“conflict” condition will be deemed to have occurred. Upon such a “contention”/“conflict” condition being determined, the corresponding “resolution value” of the received replica re-initialisation transmission and the corresponding local/resident “resolution value” may be used to resolve the detected “contention”/“conflict”. In particular, the corresponding “resolution value” of the received replica re-initialisation transmission and the corresponding local/resident “resolution value” may be examined and compared in order to determine which of the two replica values (that is, the local/resident replica value or the received replica value) will “prevail”.

Specifically then, the comparison of the two corresponding “resolution values” in accordance with a “resolution rule” may be used to compare two “resolution values” in order to consistently select a single one of the two values as a “prevailing” value. If it is determined in accordance with such rule(s) that the “resolution value” of the received replica re-initialisation transmission is the prevailing value (compared to the local/resident corresponding “resolution value”), then the receiving machine may proceed to update (overwrite) the corresponding local replica application memory location/content with the corresponding received value/content of the replica re-initialisation transmission (including overwriting the corresponding local/resident “count value” and “resolution value” with the received “count value” and “resolution value”). Alternatively, if it is determined that the “resolution value” of the received replica re-initialisation transmission is not the prevailing value (that is, the local/resident “resolution value” is the prevailing value), then the receiving machine is not to update (overwrite) the corresponding local/resident replica application memory location/content with the received value/content of the replica re-initialisation transmission (nor overwrite the corresponding local/resident “count value” and “resolution value” with the received “count value” and “resolution value”).

In one embodiment, the determination of which of two compared corresponding “resolution values” is to prevail, may be decided/determined in favour of the larger value of the two compared values (that is, in favour of the “resolution value” with the largest value/magnitude). In an alternative embodiment, it may be decided/determined that that smaller value of the two compared values is to prevail (that is, the “resolution value” with the smallest value/magnitude is decided/determined to prevail).

Furthermore, it is possible for the source computer, say computer C1, to transmit the same replica memory update transmission to each of a number of computers, say C2, C3 and C4. Under these circumstances if such replica memory update transmission is received by machines C2 and C4, but the receive buffer for computer C3 is momentarily full and therefore failed to be received by machine C3, then in a first arrangement the above described re-initialization of the corresponding replica application memory location(s)/content(s) applies to all destination computers C2, C3 and C4. However, a second improved arrangement is to restrict the re-initialization transmissions to only the computer(s) which failed to correctly receive the replica memory update transmission, which in the above example is computer C3 only. Thus, in a preferred second arrangement, a re-initialisation transmission is sent by computer C1 to computer C3, but not to computers C2 or C4 (which successfully received the replica memory update transmission that computer C3 failed to receive). This can be achieved by the switch identifying both the “replica transmission identifier” of the replica memory update transmission which was (partially) not delivered and also the identity of the computer or computers which failed to receive the replica memory update transmission (that is, computer C3 in the above example). This enables the source computer C1 to re-initialize only computer C3 and not all of computers C2, C3 and C4, thereby conserving bandwidth and capacity of the network 53.

It is also possible in a further alternative arrangement to transmit a specific signal or message from the source computer to the destination computer(s) which informs the destination computers (and potentially one or more switches or other network communications devices of the network 53) that all messages/transmissions hereafter associated/identified with a specific “replica transmission identifier”, are to correspond (or be understood to be associated with) a same identified replica application memory location(s)/content(s). As a consequence, a sequence of messages/transmissions can then consist only of the updated value or content and the associated contention “count value” and “resolution value”, without having to identify the replica application memory location/content to which they relate/correspond.

The foregoing describes only some embodiments of the present invention and modifications, obvious to those skilled in the computing arts, can be made thereto without departing from the scope of the present invention. For example, where the number of multiple computers exceeds the capacity of a single switch, then two or more switches are used, for example in a cascade connection. In the event of failure to deliver a replica memory update transmission to a (second) switch, because the in buffer of the port of the second switch connected to the first switch is temporarily full, then the first switch reports to the source computer failure to deliver to all the computers (addressed in the message) connected to the second switch (and such addressed computers connected to a third switch connected to the second switch, and so on).

Preferably, in the event of a burst of packets or messages of a single replica memory update transmission, the first of these which is not delivered triggers a notification from the switch (or other network device) to the source computer. Normally the successive packets to the same destination computer(s) will also not be delivered. Rather than have the switch send a “failure to deliver” message to the source computer for each undelivered packet, it is preferable to have the switch send only the first failure to deliver message and cancel all subsequent messages for the same “replica transmission identifier”. The cancellation of the subsequent messages can be re-set by a range of mechanisms, including after an elapsed period of time, the receipt of the re-initialization packet(s) or other packets from the source computer, or the like. Thus in one embodiment, if the re-initialization packet(s) are not themselves successfully delivered, the switch notifies the source computer to re-start the re-initialization process. Additionally, the cancellation of subsequent messages is specific to the source computer so that if another source computer attempts to send to the same inoperative destination computer, then a “failure to receive” message is sent to the second source computer.

In alternative embodiments, the “replica transmission identifiers” may take multiple forms or arrangements. For example, in one embodiment, the “replica transmission identifiers” may be a “transmission identifier” associated with all replica memory update transmissions of a same replicated application memory location/content. Alternatively in an alternative embodiment, instead of transmitting special “replica transmission identifiers” with each replica memory update transmission (or potentially each one or potentially multiple messages, packets, cells, frames or the like associated with a single replica memory update transmission), the identity or other identifier of the replicated application memory location(s)/content(s) to which the failed replica memory update transmission (and/or the failed message(s) or packet(s) comprising such transmission) corresponds, may be used in place of the “replica transmission identifiers” described above. Thus, in an alternative embodiment as this, the identity or other identifier of the replicated application memory location(s)/content(s) to which the failed replica memory update transmission corresponds become effectively the “replica transmission identifiers” for the purposes of the above description. Finally, any other arrangement of “replica transmission identifiers” may be used that facilitates or enables the operation of the above described steps. Thus regardless of which, or precisely what, form (or embodiment) the abovedescribed “replica transmission identifiers” take, what is important is that all such alternative embodiments allow the transmitting/source machine to identify the replicated application memory location(s)/content(s) to which a failed replica memory update transmission corresponds, and thereby institute a re-initialization of the effected replicated application memory location(s)/content(s) for the failed destination machine(s).

Preferably, each one of potentially multiple packets, messages, cells, frames or the like which represent a single replica memory update transmission, include the associated “replica transmission identifier”, so that should any one of potentially multiple packets, messages, cells, frames, or the like fail to be delivered, then the switch (or other network communications device) may notify the transmitting machine of the “replica transmission identifier” of the failed packet, message, cell, frame, etc.

Additionally, the abovedescribed methods of operation for switches, also more generally apply mutatis mutandis to any network communications device, such as for example but not restricted to, network interface cards, network interfaces adapters, connected computers or machines of the network 53, and the like. Thus, the abovedescribed operation of switches (and associated transmission of “failure to deliver” messages during such operation) is not to be restricted to switches, but may also more broadly apply to any alternative network communications device such as listed above.

Specifically, in a further alternative embodiment of the present invention, “failure to deliver” messages may be directly transmitted by any destination machines of a replica memory update transmission when a destination machine fails to receive (or receive fully) a replica memory update transmission.

The foregoing describes various embodiments of the present invention. It will be clear to those skilled in the computing and/or electrical engineering arts that these embodiments can be implemented in various ways. For example, at least one embodiment of the invention may be implemented by computer program code statements or instructions (possibly including by a plurality of computer program code statements or instructions) that execute within computer logic circuits, processors, ASICs, microprocessors, microcontrollers or other logic to modify the operation of such logic or circuits to accomplish the recited operation or function. In another embodiment the implementation may be in firmware and in other embodiments the implementation may be in hardware. Furthermore, in at least one embodiment of the invention, the implementation may be by a combination of computer program software, firmware, and/or hardware. In the light of the foregoing description of the operation required, the implementation is a matter of routine for the person skilled in the computing and/or electrical engineering arts.

To summarize, there is disclosed a transmission protocol for transmission of data in a communication network interconnecting at least one source of data and at least one destination for that data, the protocol comprising a payload comprising the data and a header comprising a transaction identifier, a destination address and a source address.

Preferably the protocol is modified to that the transaction identifier is omitted and the data of the payload has previously been signalled as being part of a sequence of data from the same the source to the same the destination.

Also disclosed is a method of recovery of substantially coherent memory in a replicated shared memory, or partial replicated shared memory, multiple computer system in the event of unsuccessful data transmission from a source computer to a destination computer both of which form part of the multiple computer system and the data unsuccessfully transmitted comprises the updated content of a memory location replicated in both the source computer and the destination computer, the method comprising the steps of:

(i) the source computer on becoming aware of the unsuccessful data transmission instructing the destination computer to overwrite the shared memory location to which the undelivered data relates by re-initializing the shared memory location to which the undelivered data relates, and

(ii) the source computer sending the destination computer its current contents of the shared memory location to which the undelivered data related.

Preferably the data includes a count value indicative of the position of the data in a sequence of changed data, the method including the further step of:

(iii) in step (ii) the source computer sends to the destination computer an unincremented count value.

In addition, there is also disclosed in a communications network in which data packets are transmitted via at least one multi-port switch from a source to at least one destination, the method comprising the steps of:

(i) providing the or each switch with a data processing capacity,

(ii) having the switch notify the source of any failure to deliver a packet sent from the source to any one or more of the destination(s).

In addition there is disclosed a transmission protocol for transmission of replica memory updating data in a communication network interconnecting a plurality of computers operating as a replicated shared memory arrangement, each of said computers containing and independent local memory and each said computer executing a same application program written to operate on a single computer, with at least one application memory location replicated in the independent local memory of each said computer and updated to remain substantially similar, with at least one source of data and at least one destination for that updating data, said protocol comprising a payload comprising said data and a header comprising a transmission identifier, a destination address and a source address.

In addition there is disclosed a modification of the abovementioned transmission protocol in which the transaction identifier is omitted and the data of the payload has previously been signalled as being part of a sequence of data from the same data source to the same data destination.

In addition there is disclosed a method of recovery of substantially coherent replicated application memory in a replicated shared memory, or partial replicated shared memory, multiple computer system in the event of unsuccessful replica memory update data transmission from a source computer to one or more destination computers each of which form part of said multiple computer system and said data unsuccessfully transmitted comprises the updated content of a replicated application memory location/content replicated in each of said source computer and said destination computer(s), and where each of said computers contains an independent local memory and each said computer is operating an application program written to operate on only a single computer, and with at least one application memory location/content replicated in each of said computers and updated to remain substantially similar, said method comprising the steps of:

(i) said source computer on becoming aware of said unsuccessful data transmission instructing said destination computer to re-initialise the replicated application memory location(s)/content(s) to which the undelivered data relates by re-initializing said replicated application memory location(s)/content(s) to which the undelivered data relates, and

(ii) said source computer sending said destination computer its current contents of said replicated application memory location(s)/content(s) to which the undelivered data related.

The term “distributed runtime system”, “distributed runtime”, or “DRT” and such similar terms used herein are intended to capture or include within their scope any application support system (potentially of hardware, or firmware, or software, or combination and potentially comprising code, or data, or operations or combination) to facilitate, enable, and/or otherwise support the operation of an application program written for a single machine (e.g. written for a single logical shared-memory machine) to instead operate on a multiple computer system with independent local memories and operating in a replicated shared memory arrangement. Such DRT or other “application support software” may take many forms, including being either partially or completely implemented in hardware, firmware, software, or various combinations therein.

The above methods described herein are preferably implemented in such an application support system, such as DRT described in International Patent Application No. PCT/AU2005/000580 published under WO 2005/103926 (and to which U.S. patent application Ser. No. 111/111,946 Attorney Code 5027F-US corresponds), however this is not a requirement. Alternatively, an implementation of the above methods may comprise a functional or effective application support system (such as a DRT described in the abovementioned PCT specification) either in isolation, or in combination with other softwares, hardwares, firmwares, or other methods of any of the above incorporated specifications, or combinations therein.

The reader is directed to the abovementioned PCT specification for a full description, explanation and examples of a distributed runtime system (DRT) generally, and more specifically a distributed runtime system for the modification of application program code suitable for operation on a multiple computer system with independent local memories functioning as a replicated shared memory arrangement, and the subsequent operation of such modified application program code on such multiple computer system with independent local memories operating as a replicated shared memory arrangement.

Also, the reader is directed to the abovementioned PCT specification for further explanation, examples, and description of various provided methods and means which may be used to modify application program code during loading or at other times.

Also, the reader is directed to the abovementioned PCT specification for further explanation, examples, and description of various provided methods and means which may be used to modify application program code suitable for operation on a multiple computer system with independent local memories and operating as a replicated shared memory arrangement.

Finally, the reader is directed to the abovementioned PCT specification for further explanation, examples, and description of various provided methods and means which may be used to operate replicated memories of a replicated shared memory arrangement, such as updating of replicated memories when one of such replicated memories is written-to or modified.

In alternative multicomputer arrangements, such as distributed shared memory arrangements and more general distributed computing arrangements, the above described methods may still be applicable, advantageous, and used. Specifically, any multi-computer arrangement where replica, “replica-like”, duplicate, mirror, cached or copied memory locations exist, such as any multiple computer arrangement where memory locations (singular or plural), objects, classes, libraries, packages etc are resident on a plurality of connected machines and preferably updated to remain consistent, then the above methods may apply. For example, distributed computing arrangements of a plurality of machines (such as distributed shared memory arrangements) with cached memory locations resident on two or more machines and optionally updated to remain consistent comprise a functional “replicated memory system” with regard to such cached memory locations, and is to be included within the scope of the present invention. Thus, it is to be understood that the aforementioned methods apply to such alternative multiple computer arrangements. The above disclosed methods may be applied in such “functional replicated memory systems” (such as distributed shared memory systems with caches) mutatis mutandis.

It is also provided and envisaged that any of the described functions or operations described as being performed by an optional server machine X (or multiple optional server machines) may instead be performed by any one or more than one of the other participating machines of the plurality (such as machines M1, M2, M3 . . . Mn of FIG. 1A).

Alternatively or in combination, it is also further provided and envisaged that any of the described functions or operations described as being performed by an optional server machine X (or multiple optional server machines) may instead be partially performed by (for example broken up amongst) any one or more of the other participating machines of the plurality, such that the plurality of machines taken together accomplish the described functions or operations described as being performed by an optional machine X. For example, the described functions or operations described as being performed by an optional server machine X may broken up amongst one or more of the participating machines of the plurality.

Further alternatively or in combination, it is also further anticipated and envisaged that any of the described functions or operations described as being performed by an optional server machine X (or multiple optional server m0achines) may instead be performed or accomplished by a combination of an optional server machine X (or multiple optional server machines) and any one or more of the other participating machines of the plurality (such as machines M1, M2, M3 . . . Mn), such that the plurality of machines and optional server machines taken together accomplish the described functions or operations described as being performed by an optional single machine X. For example, the described functions or operations described as being performed by an optional server machine X may broken up amongst one or more of an optional server machine X and one or more of the participating machines of the plurality.

The terms “object” and “class” used herein are derived from the JAVA environment and are intended to embrace similar terms derived from different environments, such as modules, components, packages, structs, libraries, and the like.

The use of the term “object” and “class” used herein is intended to embrace any association of one or more memory locations. Specifically for example, the term “object” and “class” is intended to include within its scope any association of plural memory locations, such as a related set of memory locations (such as, one or more memory locations including an array data structure, one or more memory locations comprising a struct, one or more memory locations comprising a related set of variables, or the like).

Reference to JAVA in the above description and drawings includes, together or independently, the JAVA language, the JAVA platform, the JAVA architecture, and the JAVA virtual machine. Additionally, the present invention is equally applicable mutatis mutandis to other non-JAVA computer languages (including for example, but not limited to any one or more of, programming languages, source-code languages, intermediate-code languages, object-code languages, machine-code languages, assembly-code languages, or any other code languages), machines (including for example, but not limited to any one or more of, virtual machines, abstract machines, real machines, and the like), computer architectures (including for example, but not limited to any one or more of, real computer/machine architectures, or virtual computer/machine architectures, or abstract computer/machine architectures, or microarchitectures, or instruction set architectures, or the like), or platforms (including for example, but not limited to any one or more of, computer/computing platforms, or operating systems, or programming languages, or runtime libraries, or the like).

Examples of such programming languages include procedural programming languages, or declarative programming languages, or object-oriented programming languages. Further examples of such programming languages include the Microsoft.NET language(s) (such as Visual BASIC, Visual BASIC.NET, Visual C/C++, Visual C/C++.NET, C#, C#.NET, etc), FORTRAN, C/C++, Objective C, COBOL, BASIC, Ruby, Python, etc.

Examples of such machines include the JAVA Virtual Machine, the Microsoft.NET CLR, virtual machine monitors, hypervisors, VMWare, Xen, and the like.

Examples of such computer architectures include, Intel Corporation's x86 computer architecture and instruction set architecture, Intel Corporation's NetBurst microarchitecture, Intel Corporation's Core microarchitecture, Sun Microsystems' SPARC computer architecture and instruction set architecture, Sun Microsystems' UltraSPARC III microarchitecture, IBM Corporation's POWER computer architecture and instruction set architecture, IBM Corporation's POWER4/POWER5/POWER6 microarchitecture, and the like.

Examples of such platforms include, Microsoft's Windows XP operating system and software platform, Microsoft's Windows Vista operating system and software platform, the Linux operating system and software platform, Sun Microsystems' Solaris operating system and software platform, IBM Corporation's AIX operating system and software platform, Sun Microsystems' JAVA platform, Microsoft's.NET platform, and the like.

When implemented in a non-JAVA language or application code environment, the generalized platform, and/or virtual machine and/or machine and/or runtime system is able to operate application code 50 in the language(s) (including for example, but not limited to any one or more of source-code languages, intermediate-code languages, object-code languages, machine-code languages, and any other code languages) of that platform, and/or virtual machine and/or machine and/or runtime system environment, and utilize the platform, and/or virtual machine and/or machine and/or runtime system and/or language architecture irrespective of the machine manufacturer and the internal details of the machine. It will also be appreciated in light of the description provided herein that platform and/or runtime system may include virtual machine and non-virtual machine software and/or firmware architectures, as well as hardware and direct hardware coded applications and implementations.

For a more general set of virtual machine or abstract machine environments, and for current and future computers and/or computing machines and/or information appliances or processing systems, and that may not utilize or require utilization of either classes and/or objects, the structure, method, and computer program and computer program product are still applicable. Examples of computers and/or computing machines that do not utilize either classes and/or objects include for example, the x86 computer architecture manufactured by Intel Corporation and others, the SPARC computer architecture manufactured by Sun Microsystems, Inc and others, the PowerPC computer architecture manufactured by International Business Machines Corporation and others, and the personal computer products made by Apple Computer, Inc., and others. For these types of computers, computing machines, information appliances, and the virtual machine or virtual computing environments implemented thereon that do not utilize the idea of classes or objects, may be generalized for example to include primitive data types (such as integer data types, floating point data types, long data types, double data types, string data types, character data types and Boolean data types), structured data types (such as arrays and records) derived types, or other code or data structures of procedural languages or other languages and environments such as functions, pointers, components, modules, structures, references and unions.

In the JAVA language memory locations include, for example, both fields and elements of array data structures. The above description deals with fields and the changes required for array data structures are essentially the same mutatis mutandis.

Any and all embodiments of the present invention are able to take numerous forms and implementations, including in software implementations, hardware implementations, silicon implementations, firmware implementation, or software/hardware/silicon/firmware combination implementations.

Various methods and/or means are described relative to embodiments of the present invention. In at least one embodiment of the invention, any one or each of these various means may be implemented by computer program code statements or instructions (possibly including by a plurality of computer program code statements or instructions) that execute within computer logic circuits, processors, ASICs, microprocessors, microcontrollers, or other logic to modify the operation of such logic or circuits to accomplish the recited operation or function. In another embodiment, any one or each of these various means may be implemented in firmware and in other embodiments such may be implemented in hardware. Furthermore, in at least one embodiment of the invention, any one or each of these various means may be implemented by a combination of computer program software, firmware, and/or hardware.

Any and each of the aforedescribed methods, procedures, and/or routines may advantageously be implemented as a computer program and/or computer program product stored on any tangible media or existing in electronic, signal, or digital form. Such computer program or computer program products comprising instructions separately and/or organized as modules, programs, subroutines, or in any other way for execution in processing logic such as in a processor or microprocessor of a computer, computing machine, or information appliance; the computer program or computer program products modifying the operation of the computer on which it executes or on a computer coupled with, connected to, or otherwise in signal communications with the computer on which the computer program or computer program product is present or executing. Such computer program or computer program product modifying the operation and architectural structure of the computer, computing machine, and/or information appliance to alter the technical operation of the computer and realize the technical effects described herein.

For ease of description, some or all of the indicated memory locations herein may be indicated or described to be replicated on each machine (as shown in FIG. 1A), and therefore, replica memory updates to any of the replicated memory locations by one machine, will be transmitted/sent to all other machines. Importantly, the methods and embodiments of this invention are not restricted to wholly replicated memory arrangements, but are applicable to and operable for partially replicated shared memory arrangements mutatis mutandis (e.g. where one or more memory locations are only replicated on a subset of a plurality of machines, such as shown in FIG. 1B).

Any combination of any of the described methods or arrangements herein are provided and envisaged, and to be included within the scope of the present invention.

The term “comprising” (and its grammatical variations) as used herein is used in the inclusive sense of “including” or “having” and not in the exclusive sense of “consisting only of”.

1. A method of a single source computer to correct for a data transmission error to another external computer wherein the single computer and the external computer have a shared memory location, said method of correction comprising:
(i) transmitting a data by a source computer to an external destination computer;
(ii) monitoring the data transmission to determine if the data transmission was unsuccessful so that the data was undelivered;
(iii) said source computer, on determining that the data transmission was unsuccessful, instructing said destination computer to overwrite a shared memory location to which the undelivered data relates by re-initializing said shared memory location to which the undelivered data relates; and
(iv) said source computer sending said external destination computer a current contents of said shared memory location to which the undelivered data related.

2. The method as in claim 1, wherein said data includes a count value indicative of the position of said data in a sequence of changed data, said method including the further step of:
(v) said source computer sending to said external destination computer an unincremented count value.

3. The method as in claim 1, wherein said data includes a count value indicative of the position of said data in a sequence of changed data, said method including the further step of:
(v) said source computer sending to said external destination computer an unincremented count value.

4. A computer program stored in a computer readable media, the computer program including executable computer program instructions and adapted for execution by a single computer to modify the operation of the single computer; the modification of operation including performing a method of a single source computer to correct for a data transmission error to another external computer wherein the single computer and the external computer have a shared memory location comprising:
(i) transmitting a data by a source computer to an external destination computer;
(ii) monitoring the data transmission to determine if the data transmission was unsuccessful so that the data was undelivered;
(iii) said source computer, on determining that the data transmission was unsuccessful, instructing said destination computer to overwrite a shared memory location to which the undelivered data relates by re-initializing said shared memory location to which the undelivered data relates; and
(iv) said source computer sending said external destination computer a current contents of said shared memory location to which the undelivered data related.

5. A method of a single destination computer to correct for a data transmission error from an external source computer wherein the single destination computer and the external source computer have a shared memory location, said method of correction comprising:
receiving, by said destination computer, an indication that a data sent to said destination computer did not receive a data transmission and that the data in said transmission was undelivered;
receiving, by said destination computer, an instruction from said source computer to overwrite a shared memory location with said source computer to which the undelivered data relates;
said destination computer in response to said received instruction, re-initializing said shared memory location in said second computer to which the undelivered data relates;
receiving, by said destination computer, from said source computer a current contents of said shared memory location from said source computer to which the undelivered data related; and
storing, by said destination computer, the received contents into its shared memory location.

6. The method as in claim 5, wherein said data includes a count value indicative of the position of said data in a sequence of changed data, said method including the further step of:
(v) said destination computer receiving from said external source computer an unincremented count value.

7. The method as in claim 5, wherein said data includes a count value indicative of the position of said data in a sequence of changed data, said method including the further step of:
(v) said destination computer receiving from said external source computer an unincremented count value.

8. A computer program stored in a computer readable media, the computer program including executable computer program instructions and adapted for execution by a single computer to modify the operation of the single computer; the modification of operation including performing a method of a single destination computer to correct for a data transmission error from an external source computer wherein the single destination computer and the external source computer have a shared memory location comprising:
receiving, by said destination computer, an indication that a data sent to said destination computer did not receive a data transmission and that the data in said transmission was undelivered;
receiving, by said destination computer, an instruction from said source computer to overwrite a shared memory location with said source computer to which the undelivered data relates;
said destination computer in response to said received instruction, re-initializing said shared memory location in said second computer to which the undelivered data relates;
receiving, by said destination computer, from said source computer a current contents of said shared memory location from said source computer to which the undelivered data related; and
storing, by said destination computer, the received contents into its shared memory location.
